(19) United States
(12) Patent Application Publication
(10) Pub. No.: US 2008/0106017 A1
(43) Pub. Date: May 8, 2008

(54) PART HOLDING DEVICE

(76) Inventor: Michel Yerly, Soulce (CH)

Correspondence Address: PEARNE & GORDON LLP, 1801 EAST 9TH STREET, SUITE 1200, CLEVELAND, OH, 44114-3108, US

(21) Appl. No.: 11/934,139

(22) Filed: Nov. 2, 2007

(30) Foreign Application Priority Data
Nov. 3, 2006 (CH) 2006CH-1744

(51) Int. Cl. B23Q 3/08

(52) U.S. Cl. 269/9; 269/104; 269/152; 269/216; 269/287; 409/131

(57) ABSTRACT

Part holding device for holding a part (1) while it is being machined, having:
a resting surface (2),
one or several mobile flanges (5) for pinning said part against the resting surface when the flanges rest against the upper side of said part, the flanges being capable of being raised when the part (1) is inserted and extracted,
one or several mobile jaws (3, 30) in a plane (X-Y) parallel to said resting surface in order to hold at least one portion (11) of said part by its lateral sides (16).

### REFERENCE DATA

The present application claims priority of Swiss Patent Application CH06/1744, the content of which is hereby enclosed by reference.

### TECHNICAL FIELD

The present invention concerns a part holding device for holding a part while it is being machined. The present invention concerns in particular a device allowing a fixed part to be held opposite a mobile tool, notably in a multi-axis machining center.

Many solutions exist in the prior art for holding a part while it is being machined. Thick parts are often held by a vice or by a jaw resting on the outer lateral sides of the part. This solution is however not adapted for holding thin parts that would become deformed by a strong pressure on their lateral sides. In particular, the machining of bridges and bottom plates in watch-making require particular protection.

There are also holding devices that make it possible to pin a part to be machined against a resting surface. One difficulty however arises when a small part one wishes to separate from a bottom plate or a large plate is being cut off. In this case, the cut-off part is generally no longer held after becoming separated. Often, the small surface of the parts to cut off does not allow them to be pinned easily, notably when the greater surface of the cut-off part must be machined.

In the prior art, cut-off parts are thus often recaptured manually or by a robot before being transferred onto a machine to be held differently. This recapture operation is costly and slows down the entire machining process.

### SHORT SUMMARY OF THE INVENTION

One aim of the present invention is to propose a part holding device free from the limitations of the known devices.

One other aim of the invention is to propose a part holding device adapted for holding flat parts during cutting-off operations.

According to the invention, these aims are achieved notably by means of a part holding device for holding a part while it is being machined, having:

a resting surface,

one or several mobile flanges for pinning said part against the resting surface when the flanges rest against the upper side of said part, the flanges being capable of being raised when the part is inserted and extracted,

one or several mobile jaws in a plane parallel to said resting surface in order to hold at least one portion of said part by its lateral sides.

The device of the invention makes it possible both to pin efficiently the machined part by means of the flanges and to hold a cut-off portion by means of the jaws moving in a horizontal plane.

The invention also concerns a method for machining a part comprising the following steps:

a) placing said part onto the resting surface of a part holding device;

b) pinning said part against said resting surface by means of one or several mobile flanges;

c) holding at least one portion of said part by moving jaws in a plane parallel to said resting surface in order to hold said portion by its lateral sides;

d) machining said part.

### BRIEF DESCRIPTION OF THE DRAWINGS

Examples of embodiments of the invention are indicated in the description illustrated by the attached figures in which:

FIG. 1 illustrates a cross section view of the device according to the invention.

FIG. 2 illustrates a cross section view of the device according to the invention, along a direction perpendicular to FIG. 1.

FIG. 3 is a top view of the device according to the invention.

FIG. 4 illustrates an example of a part advantageously machined by using a holding device according to the invention.

### EXAMPLE(S) OF EMBODIMENTS OF THE INVENTION

FIG. 4 illustrates an example of a part 1 capable of being held on a device according to the invention. The illustrated comprises an outer portion 10 and an inner portion 11. In the example illustrated, the inner portion is designed to be used as bridge or as bottom plate in a watch movement. The inner and outer portions are separated from one another by a pre-machined opening 14 and connected to one another by one or several links 12. The holding device of the invention allows for example the inner and outer portions of the part 1 to be held during cutting-off, i.e. during milling or cutting-off of the links 12 in order to separate the portions 10 and 11. Other operations can be performed on the held parts, including for example drilling, angling, engine turning, diamond finishing or other conceivable operations depending on the available tools.

The part 1 is relatively thin and comprises an upper surface 15 and a lower surface (not referenced). Traversing openings 13 allow the part to be centered on the holding device by inserting pins. The reference 16 designates the lateral sides of the inner portion 11.

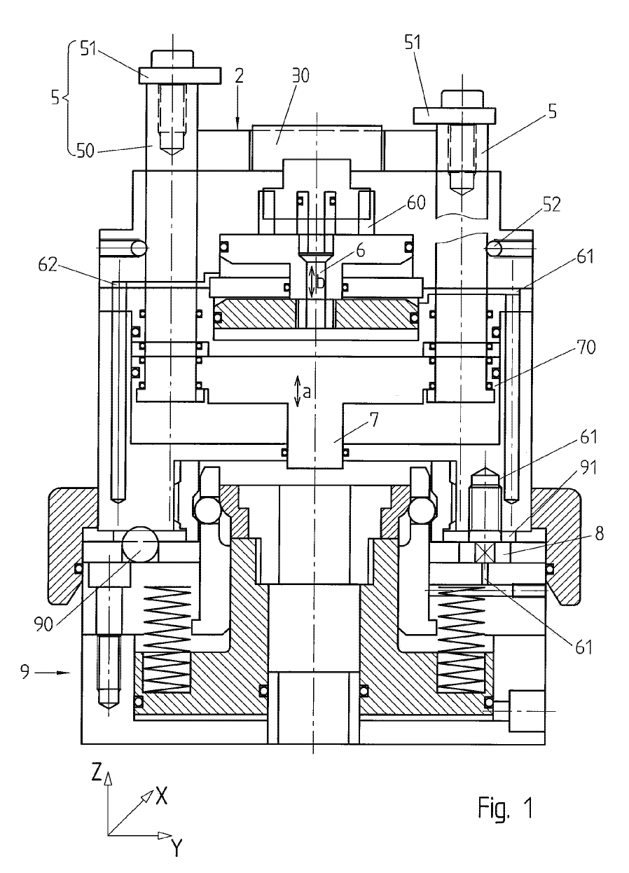

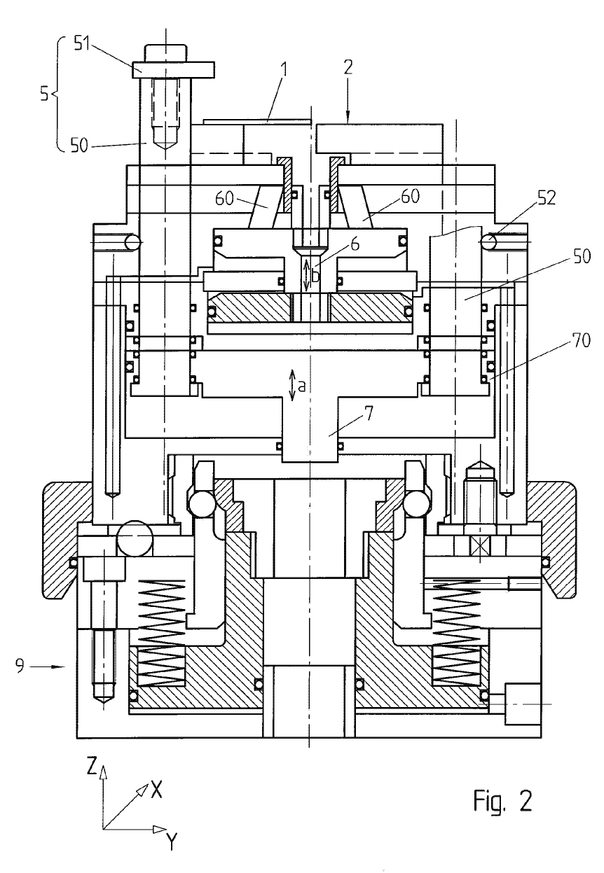

The part holding device is illustrated in FIGS. 1 to 3. The part to be machined is placed manually or with the aid of a robot on the resting surface 2 by centering it by means of pins inserted in the openings 123 of the part. In a preferred embodiment, the pins are fixedly united with bottom plates (segments) 10 machined depending on the shape of the part. The bottom plates are removable and can be replaced very easily by unscrewing the fastening screws from the device's body. It is thus possible to use the holding device with other part to be machined provided with holes or centering elements arranged differently, simply by replacing the bottom plate or plates 10. The resting surface is constituted at least partially by the upper side of the bottom plates 10. It is also possible to provide a non-plane resting surface, for example for placing a part to be machined that is of irregular thickness.

The part to be machined 1 is pinned onto the resting surface 2 by means of the flanges 5. In the illustrated embodiment, the holding device comprises 4 flanges spaced angularly by 90° from one another. A different number of flanges, for example a single flange, two flanges, three flanges to guarantee an isostatic positioning, or more than four flanges, can also be used.

Each flange comprises a rod 50 parallel to the axis Z (for example the vertical axis) as well as an eccentric resting portion 51 designed to come and rest on the upper surface of the part 1. In the illustrated embodiment, the eccentric portion is constituted by a rectangular lug of which one extremity is fastened by a screw or a bolt to the rod 50. Completely different flange shapes, including flanges with non-plane resting surfaces on the part, can be conceived as long as they can be used for holding the upper surface of the piece. The flanges can be made of steel, brass etc. or of a softer material in order not to scratch the part, for example of aluminum, synthetic material (nylon, PVC etc.) or composite (carbon fibers, etc.).

The different flanges are mobile and can be moved along the axis Z by means of a piston 7 actuated by compressed air along the arrow a. The piston 7 drives the four flanges simultaneously. In lowered position, the eccentric portions of the four flanges rest against a peripheral portion of the upper side of the outer portion of the part 1 in order to pin this part against the resting surface 2. In raised position, the flanges allow the part to be loaded before machining or its extraction after machining. In the preferred embodiment illustrated, the rods pivot by 90° during their vertical displacement in order to facilitate the insertion and extraction of the part 1 from the top of the figure. For this purpose, a metallic ball 52 of hard metal is engaged in a countersink, not represented, on the peripheral surface of the rod 50 in order to force the latter to pivot when it is displaced.

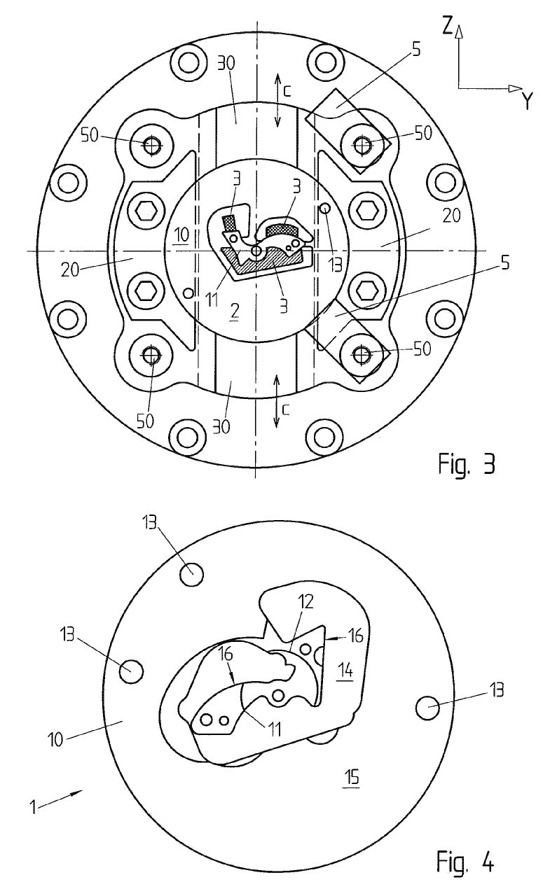

The holding device further comprises jaws 3 visible in particular in FIG. 3 and that allow the inner portion 11 of the part to be machined 1 to be held by resting on its lateral sides 16. The shape and the position of the jaws are adapted to the shape and dimensions of the inner portion 11. In the illustrated embodiment, the holding device comprises three jaws coming to rest on three disjointed portions of the lateral side 16, between the links 12. Different numbers of jaws can however be used depending on the geometry and the dimension of the part to be machined. Similarly, the jaws can be made of different materials, for example of steel, or of a softer material in order to avoid scratching the part (brass, aluminum, synthetic material such as nylon, composite material such as carbon fiber, etc.).

The jaws 3 are mounted on mobile jaw supports 30 capable of moving in the plane X-Y. The jaws 3 and the jaw supports 30 are preferably constituted of a single piece in order to avoid adjustment difficulties. In the illustrated embodiment, the two upper jaws 3 in FIG. 3 are connected to a first jaw support 30 that moves from the top to the bottom, along the arrow C, during tightening. The lower jaw is connected to a jaw support 30 that is distinct and that performs a movement of equal amplitude but of opposite direction, i.e. from the bottom to the top during closing. The two jaws thus move radially towards one another so as to center automatically the part during tightening. It is however possible within the frame of the invention to use a different number of jaw carriers, for example three jaws spaced angularly by 120° and moving radially, four jaws spaced by 90° or even a single mobile jaw moving against a fixed jaw in the manner of a vice. It is also possible to use several fixed jaws and one or several mobile jaws. The jaws or the jaw supports are preferably interchangeable and can be replaced by simple unscrewing, for example in order to machine a part with a different shape.

The jaws are actuated in the horizontal plane X-Y by means of the mobile vertical piston 6 along the arrow b. The Z-shaped movements of the piston are converted into horizontal movements by means of oblique sliding surfaces 60. The piston 6 is actuated pneumatically, just as the piston 7. FIG. 1 makes it possible to observe the air inlet 61 enabling the piston's raising to be controlled as well as the opposite air inlet 62 allowing the lowering of the piston 7 to be controlled.

The pneumatic circuit allowing the jaws 3 to be controlled is preferably independent from the pneumatic circuit controlling the flanges 5. It is thus possible to open or close the flanges independently of the jaws. In a preferred embodiment, the inventive device thus comprises four distinct compressed air inlets to control the following four displacements:

Lowering the flanges 5 to pin the part

Raising the flanges 5

Closing the jaws 3 to tighten the inner portion 11

Opening the jaws 3.

Additional air inlets can further be provided at the level of the pallet 9 in order notably to fixedly unite or disunite the support device and to clean the contact surfaces by means of a brief horizontal air jet.

The invention is however not limited to a device provided with pneumatic pistons; electromechanical actuators can also be used to actuate the jaws and the flanges. Furthermore, it is also possible within the frame of the invention to provide jaws 3 capable of moving along a vertical axis Z.

The holding device is preferably palletizable. For this purpose, its lower surface is provided with feet 8 allowing an accurate and reproducible coupling on a pallet 9, for example a pallet of the type described in the applicant's patent EP 1364746. The accuracy of the positioning is ensured notably by means of spheres 90 and of a centering plate having deformable portions. The compressed air controlling the opening and closing of the flanges and of the jaws can be injected in the inventive device through the pallet 9 through holes traversing the four feet 8.

A part 1 to be machined is first of all placed onto the resting surface 2 of the device, by hand or by means of a robot. The centering is performed with the aid of pins 13 or equivalent male or female centering elements. The jaws 3 protruding over the resting surface 2 are inserted in at least one opening 14 through the part 1.

The part to be machined is then pinned against the surface 2 by means of the flanges 5 driven downwards. The inner portion of the part is then held by means of the jaws 3 that close against the portions of the lateral surfaces of the opening 14. The part is then firmly held and can be machined, for example in order to cut off the inner portion 11 by cutting the links 12. It is also possible to perform other operations on the inner portion 11 and possibly on the outer portion 12. It is also possible within the frame of the invention to move the jaws in the plane X, Y or even along a linear axis Z or a rotation axis, at the end of a machining operation or between two machining operations. Displacements of the jaws during tightening that are not radial or that are from the inside towards the outside are also conceivable.

1. Part holding device for holding a part while it is being machined, having:
a resting surface,
one or several mobile flanges for pinning said part against said resting surface when the flanges rest against the upper side of said part, the flanges being capable of being raised when the part is inserted and extracted,
one or several jaws, said jaws being mobile in a plane parallel to said resting surface in order to hold at least one portion of said part by its lateral sides.

2. The device of claim 1, wherein said flanges can be actuated independently from said jaws.

3. The device of claim 2, wherein said mobile jaws are designed to come and rest against a portion of an opening of said part.

4. The device of claim 2, wherein said mobile jaws have a non-plane resting surface, corresponding to the resting surface of the part to be machined,
and wherein said mobile jaws are interchangeable.

5. The device of claim 4, wherein said mobile jaws are designed to come and rest against a lateral side of an opening in said part;
said mobile flanges coming to rest against a peripheral portion of the upper side of said part.

6. The device of claim 1, comprising several mobile jaws that can be moved radially in a synchronized manner in order to center automatically said part.

7. The device of claim 1, comprising at least one mobile jaw and at least one fixed jaw.

8. The device of claim 1, said mobile jaws being actuated by means of a pneumatic system.

9. The device of claim 8, comprising a mobile piston actuated pneumatically in a direction perpendicular to said resting surface, and returning means for converting the displacements of the piston into displacements of the jaws in parallel to said resting surface.

10. The device of claim 1, wherein said mobile flanges comprising each a rod and an eccentric resting portion,
said rod being capable of being displaced perpendicularly to said resting surface between a raised position allowing said part to be inserted and extracted and a lowered position allowing said part to be pinned by resting said eccentric resting portions against the upper side of the part,
said rod and said eccentric resting portion pivoting around the rod's longitudinal axis when the rod is displaced.

11. The device of claim 1, comprising three or more mobile flanges actuated simultaneously to come and rest on three different points of said part.

12. The device of claim 1, said resting surface being provided with pins or other male or female centering elements for centering said part on said resting surface.

13. The device of claim 12, said resting surface comprising at least an interchangeable plate, said pins or other centering elements being connected to said interchangeable plate.

14. The device of claim 1, the lower surface of the device being arranged to allow palletization.

15. The device of claim 14, the inner surface of the device having at least four feet.

16. The device of claim 14, comprising at least four inlets of compressed air to control the opening of the flanges, the closing of the flanges, the opening of the jaws and the closing of the jaws.

17. A method for machining a part comprising the following steps:
a) placing said part onto the resting surface of a part holding device;
b) pinning said part against said resting surface by means of one or several mobile flanges;
c) holding at least one portion of said part by moving at least one jaw in a plane parallel to said resting surface in order to hold said portion by its lateral sides;
d) machining said part.

18. The method of claim 17, said machining comprising an operation of cutting off said portion in order to separate it from the rest of the part.

19. The method of claim 18, wherein at the end of the cutting off:
said portion is held by said jaws,
said rest of the part is held by said flanges.

20. Part holding device for holding a part while it is being machined, having:
a resting surface provided with protruding elements for centering said part on said resting surface,
one or several mobile flanges comprising each a rod and an eccentric resting portion for pinning said part against the resting surface when the flanges rest against the upper side of said part,
said rod being movable perpendicularly to said resting surface between a raised position for insertion or extraction of said part and a lowered position in which said eccentric resting portions rests against the upper side of the part,
said eccentric resting portion pivoting around the rod's longitudinal axis when the rod is displaced,
said device further comprising one or several interchangeable mobile jaws moving in a plane parallel to said resting surface in order to hold at least one portion of said part by its lateral sides.

21. Part holding device for holding a part while it is being machined, having:
a resting surface,
one or several mobile flanges for pinning said part against the resting surface when the flanges rest against the upper side of said part, the flanges being capable of being raised when the part is inserted and extracted,
one or several jaws, said jaws being mobile in a plane parallel to said resting surface in order to hold at least one portion of said part by its lateral sides,
wherein the device is arranged to allow palletization for charging or discharging said part on a pallet.
